(19) United States
(12) Patent Application Publication
(10) Pub. No.: US 2015/0229491 A1
(43) Pub. Date: Aug. 13, 2015

(54) Cost-Effective Core System for Mobile Networking

(71) Applicants: Dmitry Solovyev, Moscow (RU); Leonid ARBATMAN, Mountain View, CA (US)

(72) Inventors: Dmitry Solovyev, Moscow (RU); Leonid ARBATMAN, Mountain View, CA (US)

(21) Appl. No.: 14/576,217

(22) Filed: Dec. 19, 2014

Related U.S. Application Data
(60) Provisional application No. 61/918,988, filed on Dec. 20, 2013.

(51) Int. Cl. H04L 12/66; H04W 8/14

(52) U.S. Cl. CPC H04L 12/66; H04W 8/14; H04W 92/02

(57) ABSTRACT

One of the actual trends of mobile industry is deploying LTE in addition to existing 2G/3G networks, with further migrating towards VoLTE. There are multiple reasons for an operator to keep multiple network standards running in parallel. Thus, a sophisticated mixture of core network infrastructure is involved. By means of the proposed invention, 2G/3G radio access network can be attached directly to VoLTE core network, thus essentially reducing core network complexity and operating expenses. The invention enables to rely on IMS core and reuse it's infrastructure to run conventional GERAN/UTRAN and roaming, thus eliminating eMSS and SS7 core completely, without impact on services and billing.

### FIELD OF THE INVENTION

The invention relates to a new cost-effective SIP-based full featured GSM network system and to a method of interfacing 3 GSM/UMTS RAN directly to 3 VoLTE core.

The statements below ere referencing to 2G networks, but most eases are applicable to 3G as well,

### GLOSSARY OF TERMS USED IN THE SPECIFICATION

The following terms are used generally in this specification, subject to context, as defined here:
2G Second Generation
AAA Authentication, Authorization and Accounting
BICC Bearer-Independent Call Control
BSC Base Station Controller
BSSAP Base Station System Application Part
BTS Base Transceiver Station
CAMEL Customized Applications Mobile Network Enhanced Logic
CAP CAMEL Application Part
CFU Call Forwarding Unconditional
CS Circuit Switched
CSI CAMP Subscription Information
CSFB Circuit Switched FallBack
eMSS Enhanced Mobile Switching center Server
GERAN Global System for Mobile Communications/EDGE Radio Access Network
GSM Global System for Mobile Communication (formerly: group speciale mobile)
gsmSCP SCP (Service Control Point) as specified for GSM
gsmSSP SSP (Service Switching Point) as specified for GSM
HLR Home Location Register
HSS Home Subscriber Server
ICS IMS Centralized Services
IMPI IMS Private user identity
IMSI International Mobile Subscriber Identifier
IMS Internet protocol Multimedia Subsystem
IM-SSF Internet protocol Multimedia Service Switching Function
IP Internet Protocol
ISIM IP multimedia Services Identity Module
ISUP ISDN User Part
IVR Interactive Voice Response
LAC Location Area Code
LTE Long Term Evolution
MAP Mobile Application Part
MNO Mobile Network Operator
MO Mobile Originating
MSISDN Mobile Station Integrated Services Digital Network Number
MSRN Mobile Station Roaming Number
MT Mobile Terminating
MTP Message Transfer Part
OCS Online Charging System
PLMN Public Land Mobile Network
PRN Provide Roaming Number
PSTN Public Switched Telephone Network
RAN Radio Access Network
SCCP Signaling Connection Control Part
SCF Service Control Function
SCP Service Control Point
SDR Software-Defined Radio
SIM Subscriber Identification Module
SIP Session Initiation Protocol
SMSC Short Message Service Center
SS7 Signaling System no. 7
SSF Service Switching function
SSP Service Switching Point
TCAP Transaction Capabilities Application Part
TCP Transmission Control Protocol
TDM Time Division Multiplex
UA User Agent
UE User Equipment
UICC Universal Integrated Circuit Card
URI Universal Resource identifier
USIM Universal Subscriber identity Module
USSD Unstructured Supplementary Service Data
VLR Visitor location Register
VoIP Voice over IP
VoLTE Voice over LTE.

### BACKGROUND OF THE INVENTION

A conventional up-to-date GSM/UMTS network system consists of several major nodes such as an MSC/gsmSCP, HLR, a number or BSC-s, gsmSSP and auxiliary elements such as a SMSC, USSD, IVR, voice mail etc. It is essential that all these nodes are interconnected with various SS7 protocols with ISUP, MAP, CAP (CAMEL) and BSSAP (RANAP) as application level subsystems. Penetration of VoIP changes core networks as well: networks are migrating from outdated TDM technology to ip, but for 2G+ networks it leads to substitution of ISUP call control with VoIP (SIP, BICC etc.) and SS7 lower layers with Sigtran, while the key protocols like MAP and CAMEL remain the same which are a must for roaming.

Another trend is domination of SIP in the VoIP world, including mobile. For the modern mobile standards, the Diameter suite of protocols replaces SS7 in mobile-specific aspects, and networks ate built with a packet backbone. The Diameter is developed to meet ip realities and it is native for packet networking. So, Diameter is the major control protocol for an LTE core that is aimed to provide data connectivity to a subscriber, and SIP+Diameter are needed to run IMS. Another feature of modern mobile networking is a wide band demanded both at the core side and over the radio interface.

The SDR technology is spreading, making mobile network equipment cost effective and flexible, so it is not only an ip backbone and core that becomes standard-agnostic and easy to upgrade, but a radio subsystem as well.

Some of prior set systems related to the present invention are listed below.

US Patent Application Publication No 2003o225812 A1 describes an SDR approach for building GSM base station and SIP interface for interconnecting BTS to a conventional VoIP network. The VoIP-only BTS is a cellular base transceiver station designed to achieve low operating costs and increased flexibility through the following features:
1) Use of a software radio approach that allows layer 3 and control layer of the BTS to have close communication with the physical layer functions of the radio.
2) Movement of the telephone call switching functions into the BTS, allowing it to use VoIP for call placement, bypassing nearly all of the conventional cellular infrastructure, cutting backhaul requirements, and replacing specialized leased-line (SS7, etc.) equipment with commodity Ethernet and wireless LAN networking components.
3) Adaptive automation of the radio configuration, making one cellular network maintainable by ordinary information technology workers, not cellular specialists.

US Patent Application Publication No 20090059846 describes a method for coordinating the operation of cellular base stations through the use of direct communication among those base stations. This is a departure from the use of “radio network control” (RNC) elements such as the base station controller (BSC) and mobile switching center (MSC) of the GSM standard and functionally equivalent elements use in other cellular standards. According to the applicants of the aforementioned application, the replacement of the RNC elements with direct communication among base stations gives a network that is less expensive and more reliable that what is afforded by current practices.

U.S. Pat. No. 8,068,469 B2, US Patent Application Publication 20120219127, U.S. Pat. No. 7,912,042 B2, and U.S. Pat. No. 8,233,476 describe interconnection of non-IMS endpoints to IMS networks thus providing a surrogate registration.

The U.S. Pat. No. 7,738,426 B2 describes a roaming gateway with the reverse functionality (compared to presented invention) and is intended to enable IS-41/GSM subscribers to roam in packet network, and emulates VLR or an MSC to the HLR.

The U.S. Pat. No. 8,331,384 B2 proposes an architecture for serving 3G femto concurrently in IMS and legacy cores.

An interworking mobile switching center proposed in the U.S. Pat. No. 6,954,654 B2 also emulates UA on behalf of a subscriber and also behaves like the P-CSCF within the UMTS IMS. On the other side, it performs as a complete MSC, interacts with HSS and is not intended to eliminate conventional core network; our invention is aimed at reducing a conventional mobile core, putting all operations under IMS control, with minimal impact on IMS infrastructure.

### SUMMARY OF THE INVENTION

The present invention is a new approach to building a backbone of a full-featured cost effective mobile network. A complete mobile network operation is split into logical functional units that are bundled with SIP procedures. Such an approach significantly reduces software complexity, both initial investments in network deployment and operational costs.

This approach can be optimal to build a new cost-effective network from scratch, as well as to significantly reduce both complexity and operational expenses when VoLTE is deployed in parallel with exiting 2G/3G networks.

As a generic case, a complete network architecture that is optimal for deploying a Greenfield network is offered. GSM network is being adapted so a common SIP one in terms of compatibility, procedures, network operation and billing yet a network remains a full-featured cellular one in all aspects such as mobility, handover, GSM MAP for incoming and outgoing roaming and optionally a needed level of CAMEL support.

A newly-created network core can control conventional GSM radio subsystem, interfaced over a legacy A-interface as well as newly-created GSM radio infrastructure with ip backbone.

The system of the invention fits the requirements for cost-effective extending of an existing mobile network with both postpaid and prepaid subscribers. The system is interfaced to a mainland network with MAP and SIP, and credit control is performed by direct connecting of an ordinary VoIP soft switch over any AAA protocol to existing billing.

If an LTE operator is using CSFB technology for calls and extends 2G coverage in accordance with the given proposal, alongside with existing 2G/3G network, the present invention can still be used. In this case a new network element is introduced that substitutes eMSS and stands in between a conventional eMSS and the remained LTE core network.

The major idea of the invention is the concept of direct interconnection of the conventional CS UTRAN/GERAN into IMS (VoLTE) environment.

One of the gateway being proposed, so-called RAN GW, can natively interconnect 2G/3G RAN to IMS or VoLTE network over BSC (A-interface), RNC (luCS) or even SIP-adapted BTS interface. This is a sort of Registration Surrogate technique when a SIP user is emulated at network side, opposite to IMS practice where a user terminal runs SIP, that assumes ip transport to a handset. In the proposed solution, a band-effective switched GSM/UMTS radio interface is kept, so any ordinary (even non-Smartphone) GSM/3G handset can be served by VoLTE core. RAN GW, acting as P-CSCF of the home network, just emulates a behavior of an IMS terminal creating a virtual IMS UE for each IMSI registered, keeping a legacy 2G/3G radio interface and legacy handsets behind, without any demands to a handset, ip data channel etc. Compared to VoLTE, where mobility is abstracted by underlying LTE layer, the proposed system implements mobility functions, including handover, with SIP. It is essential to mention that no 2G/3G network core elements are required. As an essential part of mobility support, SIP-assisted handover procedure is proposed.

Such an approach can be also useful when providing cost-effective cellular coverage for remote areas with limited bandwidth of a backbone network-interfacing GSM radio network segments to a general IMS core without deploying any 2G core network infrastructure.

if VoLTE operator replaces 2G/3G core network with the proposed solution, it preserves all needed functionality, that is:
serving own subscribers in both IMS and 2G/3G CS domains, interfacing to billing and OCS
permitting own subscribers to roam in 2G/3G networks
accepting roamers from conventional 2G/3G networks both with and without CAMEL subscription
IMS (VoLTE) services, including roaming, are not affected in any way.

The key advantages of the invented network infrastructure are:
maximal reuse of existing IMS network nodes alongside with the simplicity of the new nodes being proposed
minimal impact on the existing IMS network configuration, billing etc.

### BRIEF DESCRIPTION OF THE DRAWINGS

FIG. 1 shows a SIP-based GSM core network according to the invention.

FIG. 2 illustrates a handover call flow essentials according to the invention.

FIG. 3 illustrates the case when the invention is deployed at LTE network with CSFB, and explains the respective connectivity.

FIG. 4 shows newly-introduced RAN-GW within IMS.

FIG. 5 illustrates additional S-CSCF interfacing to serve IMS subscribers when in CS GERAN/UTRAN.

FIG. 6 shows a special AS to process user-related activities when in GERAN/UTRAN, as Unregistered IMS subscribers.

FIG. 7 illustrates a gateway to enable IMS subscribers to roam in 2G/3G networks.

FIG. 8 shows IMS control of 2G/3G MO call in roaming, when a call is delivered to home network; call path is shown, CAMEL transactions are omitted.

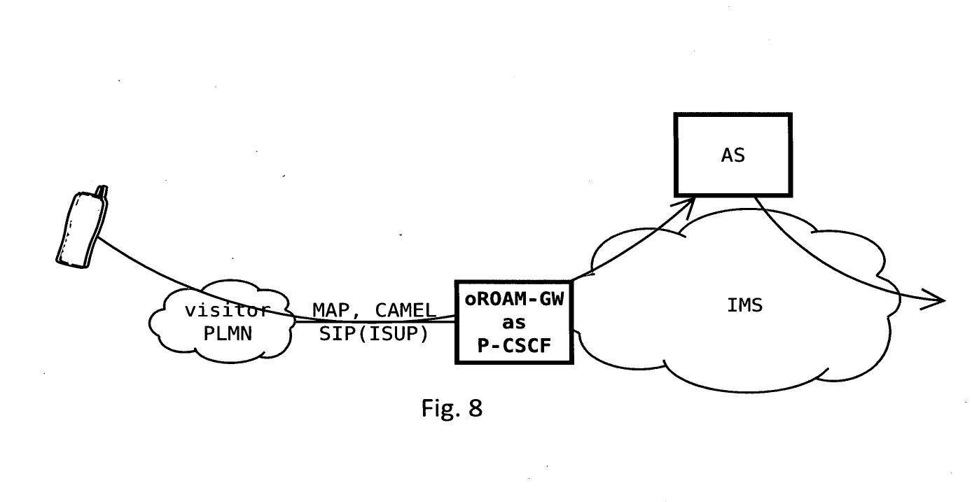

FIG. 9 shows IMS control of 2G/3G MO call in roaming, that is controlled by CAMEL, without delivering a call to home network.

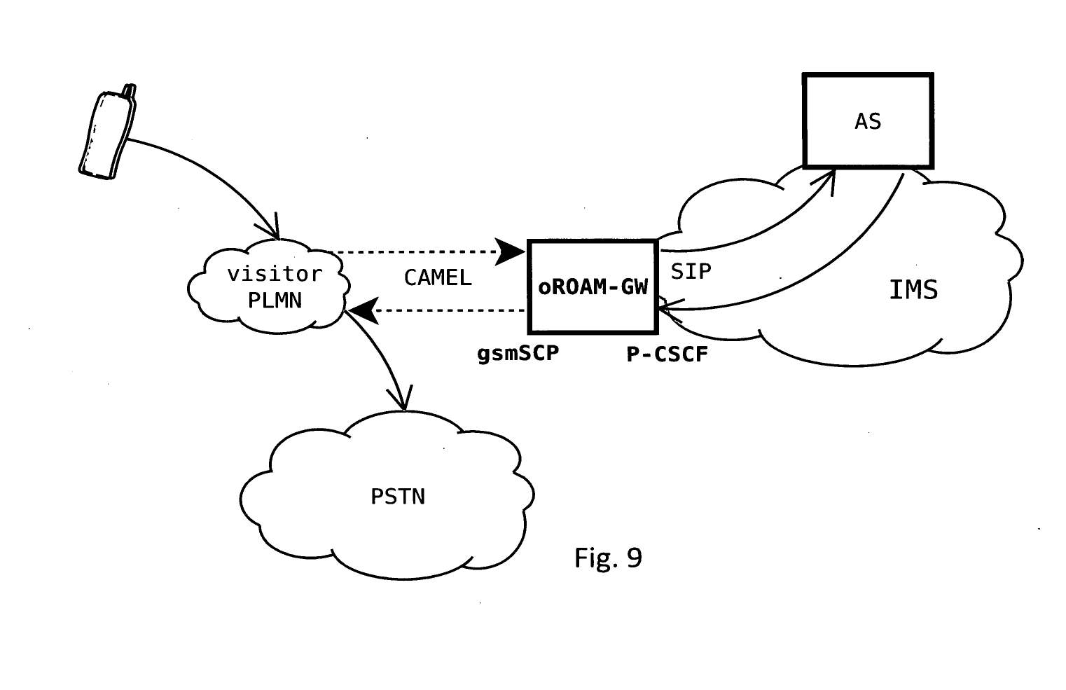

FIG. 10 illustrates a gateway to serve 2G/3G roamers within IMS-controlled GERAN/UTRAN.

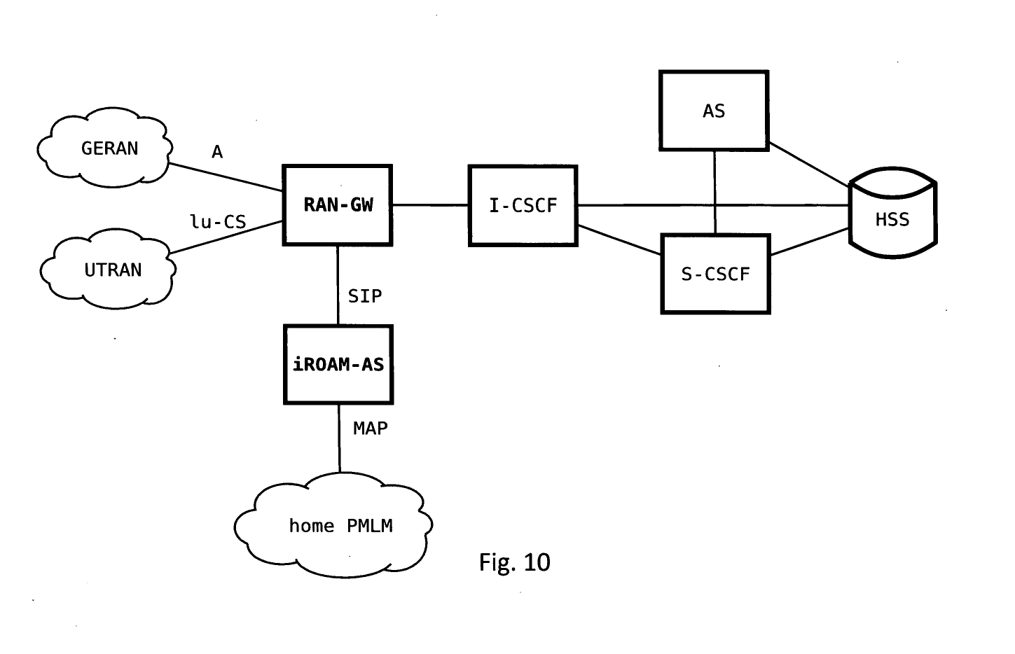

### DETAILED DESCRIPTION OF THE INVENTION

Interfacing RAN to SIP opens a door for implementing mobile core network in cost-effective ways. Two cases presented below are optimal either to build a full-featured cost-effective mobile network from scratch, or to radically simplify the network infrastructure in the case of a mixed deployment of 2G/3G and VoLTE networks.

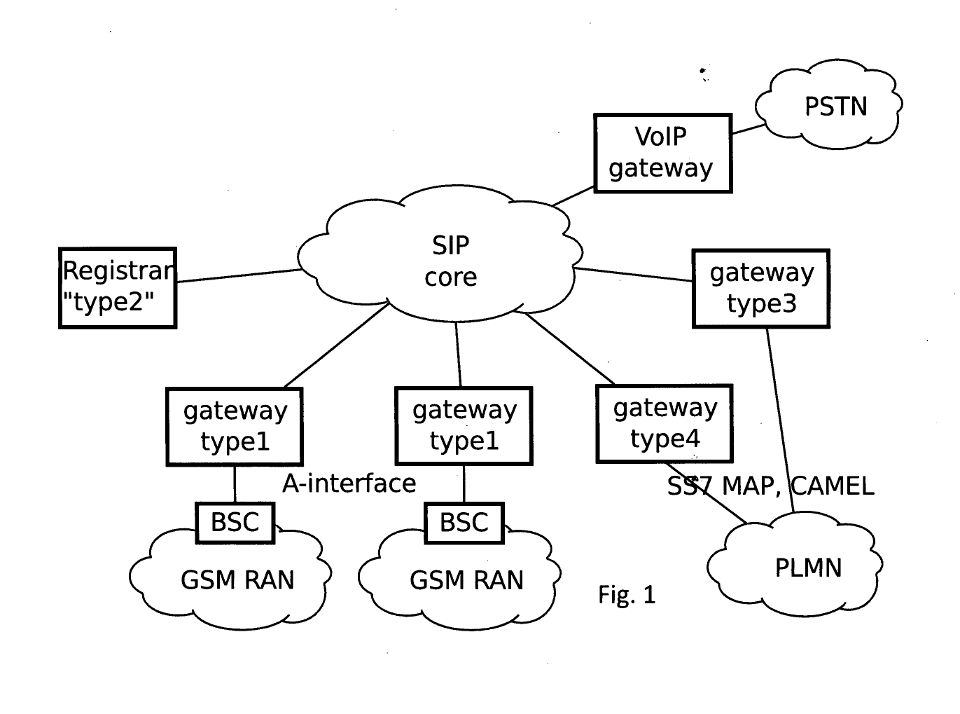

FIG. 1 presents the proposed SIP-based implementation of GSM core, Gateway type1 interfaces a BSC to SIP, registrar type2 acts as a sort of an HLR, gateway type3 emulates a VLR, allowing foreign subscribers to be served, and a gateway type4 permits own subscribers to roam, exposing like HLR to the outer world, while behaving essentially in the the same way as a gateway type1 from SIP point of view.

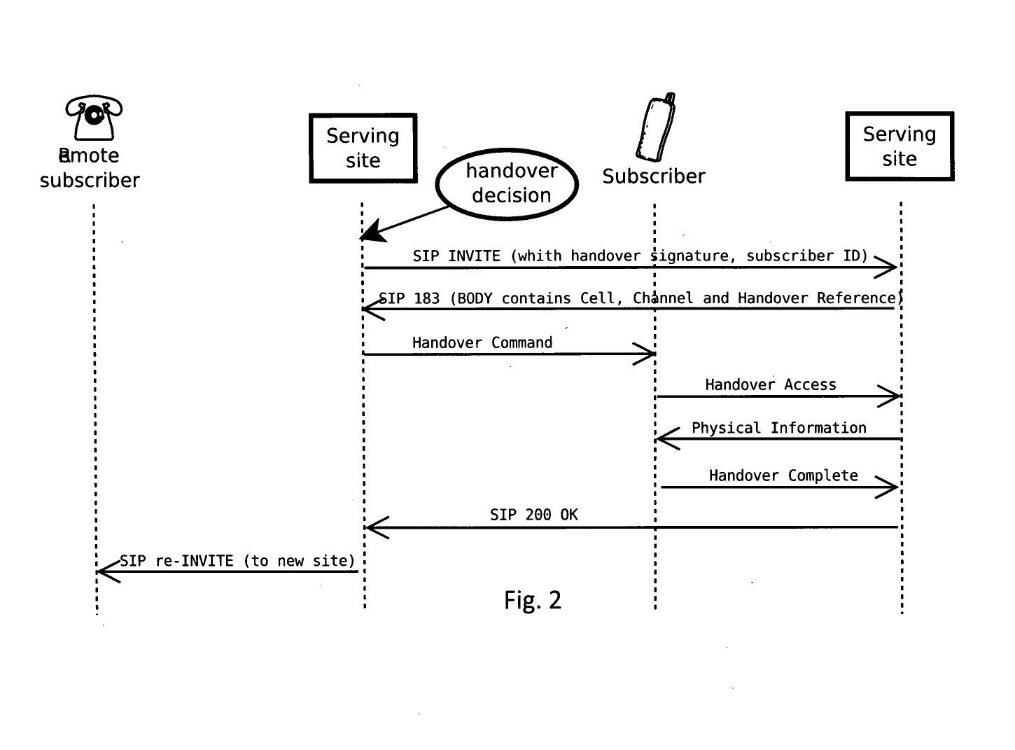

Obvious SIP auxiliary messages dictated by SIP call flow are omitted, and an example with SIP-based handover essentials for non synchronized cell case (GSM 04.08 3.4.4.2.2) is shown on the FIG. 2. Regardless the way how a handover decision is taken, an old node triggers SIP call setup to a new node, where SIP call ID contains a signature of a handover call. In response, a new node provides a serving cell with handover specific data in SIP body. A serving node fires HandoverCommand over Um interface, pushing a handset to a new cell. When Um procedure with a new cell succeeds, a new node acknowledges call setup; afterwards an old node performs activities to re-route call related rtp traffic to a new destination.

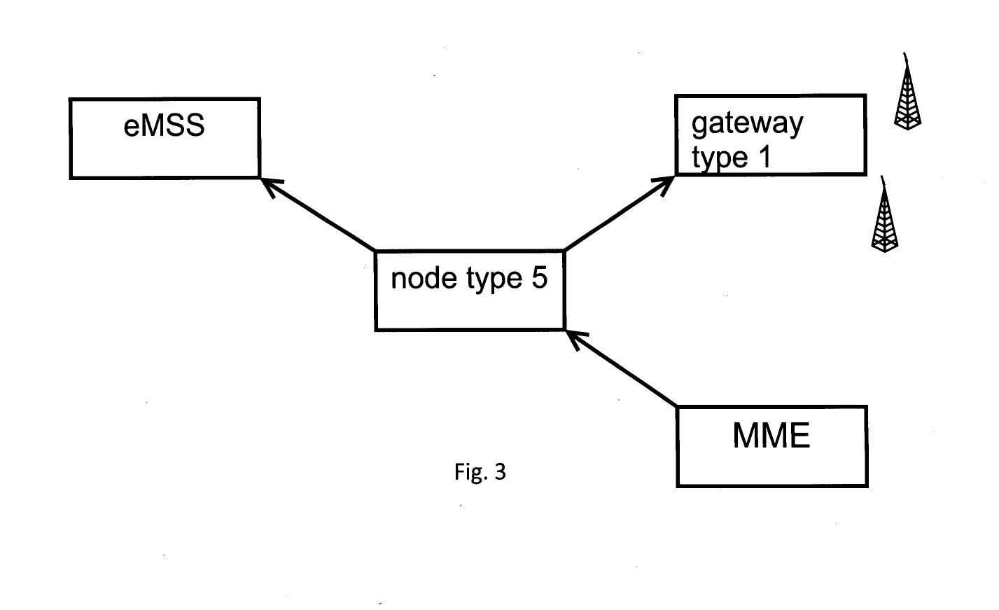

If an operator is using CSFB technology for calls, it still can use the invention to extend 2G/3G network coverage without connecting it to eMSS. It can be assumed that the common case is as follows: LTE and a legacy network used for fallback are providing partially overlapping coverage, while a proposed extension exceeds LTE coverage and should be kept after the original network has been swapped. In such a case, a network node is proposed to enable CSFB to both conventional and newly-introduced RAN as shown on FIG. 3.

When a stand-alone network is deployed, for example, in case of emergency, and serves all handsets within an area without authenticating, regardless which operator a given SIM card belongs to, interfacing to its HLR makes it possible to fetch MSISDN. In such a way, all compatible handsets within an area can be served with their original MSISDMs in a newly-deployed network.

### Interfacing GERAN/UTRAN Directly to IMS.

The key goal of the given invention is to provide a solution for significant infrastructure reduction and simplification without decreasing functionality when VoLTE is deployed alongside with the existing 2G/3G network. The challenge is to simplify the sophisticated core network, that combines 2G/3G infrastructure, EPC and IMS, by reducing 2G/3G SS7 core, connecting existing BSCs and RNCs directly to IMS, integrating them into IMS with minimal impact on it. So, the same MMTel application servers from IMS should handle regular activities for these 2G/3G subscribers, and other IMS nodes should perform in their conventional manner as well.

GERAN/UTRAN can be directly embedded into IMS core within a home network. Such a node, referred as RAN gateway—RAN-GW, should interface BSC/RNC as one side and emulate P-CSCF behavior from IMS perspective.

There are several essential issues while replacing SS7 core with IMS, when 2G/3G coverage and roaming is to be preserved:
first of all, in 2G/3G mobile networks the visited service control is in use, and in IMS a home service control is implemented; thus, the node that accesses subscriber database and interacts with service platforms is located at the user's home network,
as a handset is connected over CS radio interface, ISIM profile is not accessible, so authentication (both at radio interface and inside IMS core) should be performed with GSM mechanisms that are unacceptable for VoLTE
mobility in IMS is provided by underlying layer (like LTE), while in the conventional mobile network it is performed by MSC: thus, the proposed system should implement handover in an alternative way, both within 2G/3G coverage and for SRVCC
algorithms of mobile terminated call handling in roaming essentially differ in 2G/3G and IMS approaches.

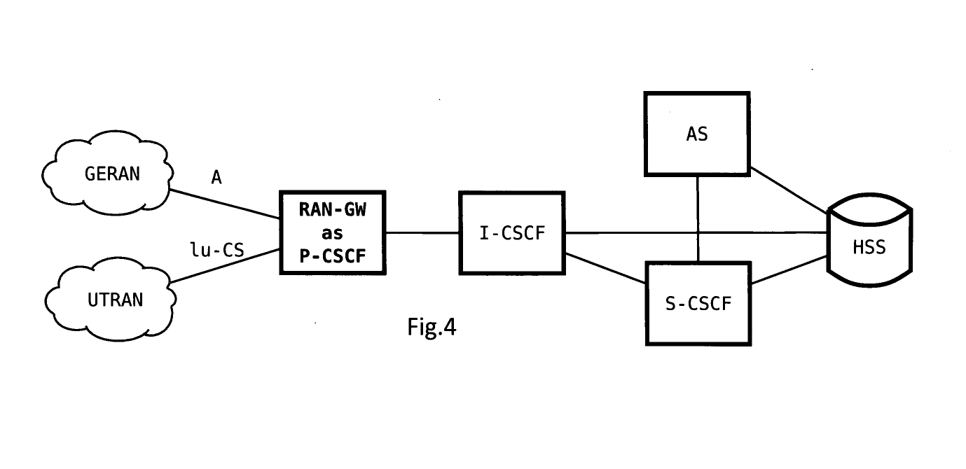

The RAN-GW (radio access network gateway) being proposed can natively interconnect GERAN/UTRAN no IMS network over BSSAP/RANAP as shown on FIG. 4. This is a kind of Registration Surrogate technique when a SIP user is emulated at a network side, opposite to IMS practice where a user's terminal runs SIP, that assumes ip transport to a handset. In the proposed solution, 2G/3G CS radio interface is preserved, so any ordinary (even non-Smartphone) GSM handset can be served by VoLTE core. Such a gateway just emulates a behavior of an IMS terminal creating a virtual IMS UA for each IMSI registered, keeping a legacy GMS/UMTS radio interface and legacy handsets behind, without any special requirements so a handset, and no need of ip data channel etc. Compared to VoLTE, where mobility is abstracted by underlying LTE layer, the proposed system implements mobility aspects, including handover, with SIP. It is essential to mention that no conventional core network nodes needed.

Handover procedure between RAN-GW nodes is performed by means of SIP as described above. SRVCC between the real VoLTE and a newly-introduced RAN, acting on behalf of RAN-GW (P-CSCF) is performed in a way similar to inter-RAN-GW handover, that is like inter-BSC handover over SIP as proposed.

Authenticating of a subscriber over radio interface is performed in a conventional way, as defined by the given RAN technology. The challenge is to perform IMS registration, since the ISIM profile is unavailable. The task is to authenticate and register the own IMS subscriber, when the emulated P-CSCF is located in a home network; visitors, as non-IMS, are served within GERAN/UTRAN over a dedicated gateway that exposes GSM MAP (and, optionally, CAMEL) or Diameter to 2G/3G partner's network—a visitor should have 2G/3G roaming capabilities to be served in a conventional mobile network.

If Diameter interface between S-CSCF and HSS is being monitored, RAN-GW can provide an expected response to the authentication challenge.

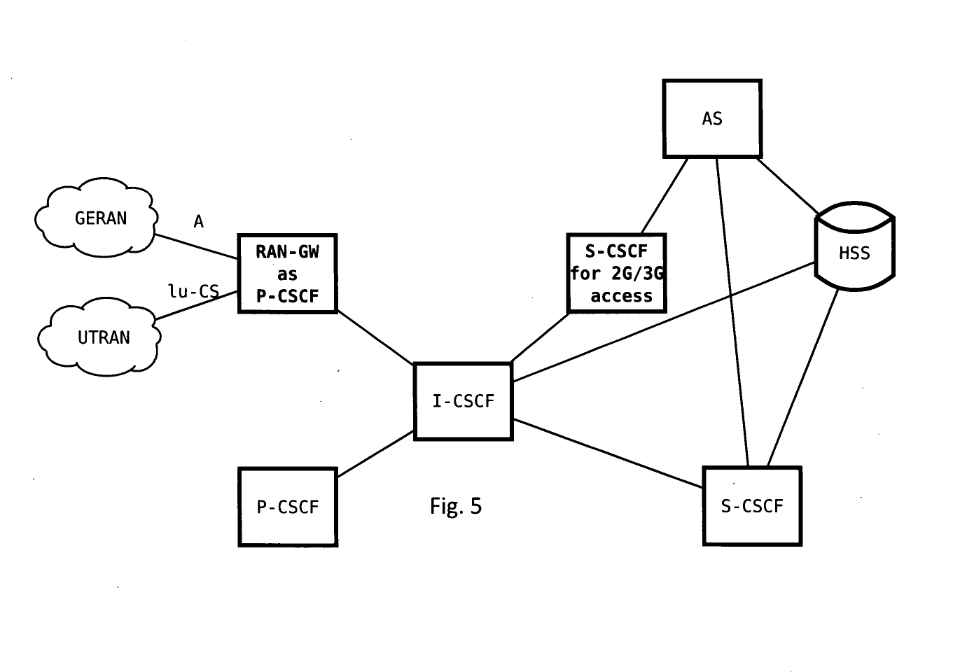

As another option, requests from the given P-CSCF (ea RAN-GW) can be routed to a dedicated S-CSCF with alternative (“downgraded”) 2G/3G authentication mechanisms as shown on FIG. 5, enabling registration of IMS subscriber over GERAN/UTRAN when data from ISIM is unavailable due to radio technology involved in between the handset and the network.

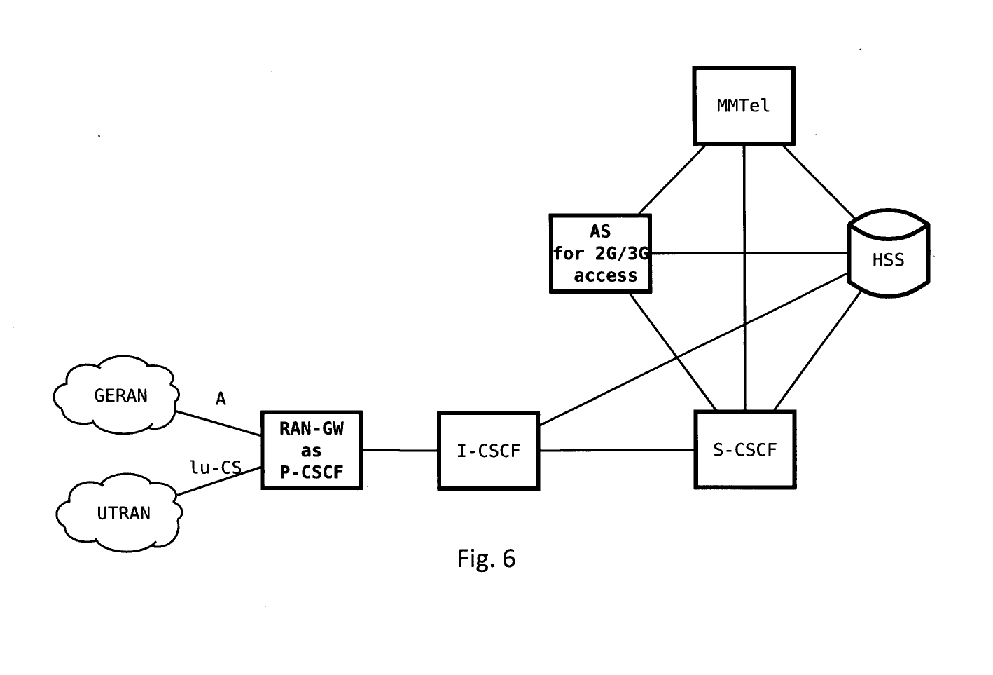

Finally, a subscriber profile can be enriched with service point triggers to route any activities from/for 2G/3G-capable users, as unregistered, to the certain AS as shown on FIG. 6; all registrations can be held within a dedicated AS itself, so it could function as an “HLR” for MO/MT activities, without registering a subscriber's location in HSS in a standard manner. So, initial Registration can be replaced by any SIP transaction that would be delivered (by S-CSCF as an activity from unregistered subscriber) to a dedicated AS. Thus, a MT call for a given subscriber will be served in S-CSCF in accordance with a service point trigger as a call to unregistered user, and it would be forwarded to the same AS (or a group of AS-s). This AS must register the subscriber in MMTel and other AS-s where applicable. Such an AS can supply either its own address, or address of S-CSCF, that was involved into routing SIP message from a RAN-GW (that performs as P-CSCF), in SIP Service-Route parameter, to ensure that this particular AS will be involved into serving originating traffic from a given subscriber. HSS can be used (over Sh interface) to store the data needed for delivering a call/message to a given subscriber (that is unregistered in S-CSCF); such data is needed by AS that will serve MT activity for an “unregistered” (from S-CSCF's perspective) subscriber. It is clear that such an AS, that proxies 2G-3G located subscriber's activities, must be the first choice for unregistered subscribers, before MMTel server: if subscriber is not registered in 2G/3G RAN, AS will forward a request to MMTel as a really unregistered (ea. to receive a voicemail message etc.).

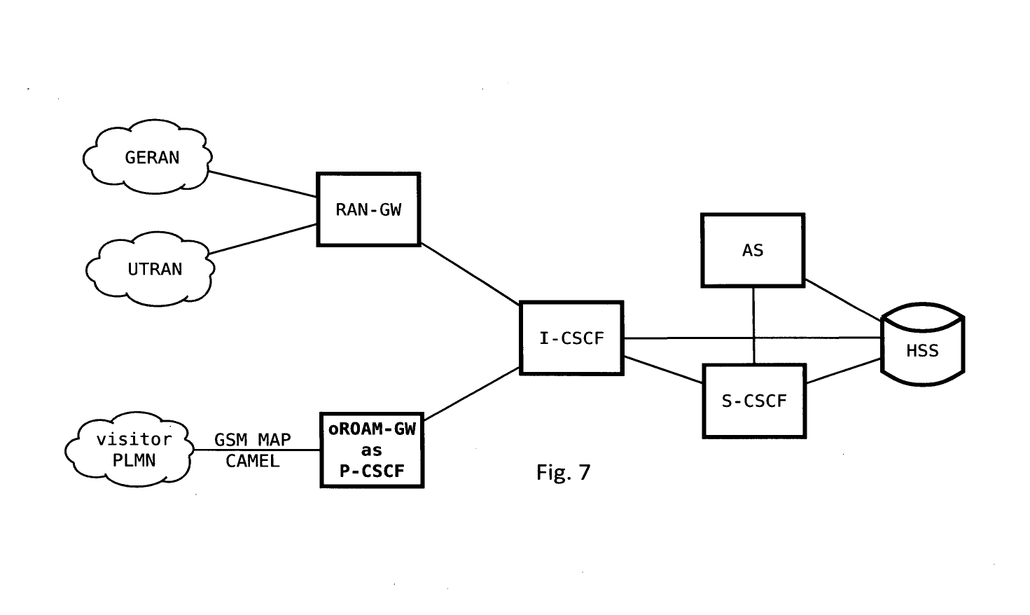

To permit IMS subscribers to roam in 2G/3G world, oROAM-GW (outbound roaming gateway) is introduced as shown on FIG. 7. Similar to RAN-GW, oROAM-GW emulates lust another P-CSCF within a home network, and exposes GSM MAP or Diameter to roaming partners (and optionally CAMEL if also acting as gsmSCF).

There are several options to involve S-CSCF and AS-s into controlling mobile originated activities in 2G/3G roaming, like in IMS case:
if oROAM-GW forces (by means of CAMEL) a serving network to route a call to the home network, such a call appears in IMS as if it was originated from a given P-CSCF (oROAM-GW). The drawback is to deliver such a call to the home network.
As an alternative, if an AS will route the second leg of the MO call hack to the same oROAM-GW, such a gateway can perform CAMEL-SIP conversion, acting as gsmSCF, as opposite to IM-SSF. So, MO call will remain within a visiting network, being controlled over CAMEL. Meantime, from the home network (ea. IMS) perspective, the call is controlled and charged by AS in a conventional manner, as if the given emulated P-CSCF is located in a visitor network and is serving a MO call.

1-33. (canceled)

34. A system for mobile networking comprising:
a core network, the core network having a plurality of dedicated gateways, the gateways being interconnected by a session initiation protocol (SIP), the network further having:
a plurality of public land mobile networks (PLMNS) having a signaling system map and application mobile network logic;
SIP switches within the core network; and
mobility applications including handover and roaming.

35. The system of claim 34 further comprising a base station controller (BSC) and a visitor location register (VLR), wherein the gateways interface to the base station controller, receive data from the visitor location register, implement mobile originating and mobile calling and messaging using procedures for unstructured service data, and handle inter base station controller handover procedures.
